(19) United States
(12) Patent Application Publication
(10) Pub. No.: US 2011/0241610 A1
(43) Pub. Date: Oct. 6, 2011

(54) BATTERY CHARGER, BATTERY CHARGING CIRCUITS, AND SEMICONDUCTOR INTEGRATED CIRCUIT DEVICES

(75) Inventors: Takahiro Watanabe, Hamura (JP); Yoshitaka Abe, Ome (JP); Yoshihiro Hayashi, Akishima (JP); Makoto Tabuta, Hanno-shi (JP); Motonobu Fujii, Hanno-shi (JP)

(73) Assignees: HITACHI,LTD.; Shindengen Electric Manufacturing Co., Ltd.

(21) Appl. No.: 13/026,583

(22) Filed: Feb. 14, 2011

(30) Foreign Application Priority Data
Mar. 31, 2010 (JP) JP2010-081064

(51) Int. Cl. H02J 7/04

(52) U.S. Cl. 320/108

(57) ABSTRACT

There is provided a battery charging technique by which various battery charging control can be achieved even when power consumption of a battery is small. In a battery charger, in order not to turn OFF a power switch even when an ACG starting detection circuit recognizes that an output of a generator is not generated in a state in which the power consumption of the battery is small and the voltage of the battery is not dropping, a voltage of the battery in addition to phase terminal signals of a three-phase alternating-current generator is inputted to the ACG starting detection circuit, and the ACG starting detection circuit controls not to turn OFF the power switch when the output of the three-phase alternating-current generator is generated or when the voltage of the battery is equal to or higher than a predetermined voltage.

### CROSS-REFERENCE TO RELATED APPLICATION

The present application claims priority from Japanese Patent Application No. 2010-081064 filed on Mar. 31, 2010, the content of which is hereby incorporated by reference into this application.

### TECHNICAL FIELD OF THE INVENTION

The present invention relates to a technique for battery charging. More particularly, the present invention relates to a technique effectively applied to a battery charger, a battery charging circuit, and a semiconductor integrated circuit device for battery charging control for a two-wheel vehicle.

### BACKGROUND

Conventionally, various battery chargers for two-wheel vehicles have been proposed. For example, in a battery charger disclosed in Japanese Patent Application Laid-Open Publication No. 2001-286074 (Patent Document 1), a method of reducing battery power loss caused by a leakage current from a charging control circuit and other circuit units in a state in which an output of a generator is not generated is disclosed.

### SUMMARY

Incidentally, in the above-described battery charger disclosed in Patent Document 1, to which output of a permanent-magnet-type three-phase alternating-current generator (ACG) is inputted and which charges a battery by a DC voltage rectified by a three-phase full-wave rectifier, the battery charger includes: a Schottky-barrier-diode group connected to a positive side of the three-phase full-wave rectifier; and a FET group connected to a negative side thereof, an ACG starting detection circuit is connected to output of each phase of a generator, and a power switch connected between a positive side of the battery and a charging control circuit is controlled by the output of each phase.

The above-described configuration has characteristics such that, a gate terminal of each FET is to be at a positive bias (H level) in accordance with the timing (zero-cross) of synchronous rectification when an AC input voltage is negative, the gate terminal of each FET is to be at a ground potential (L level) in accordance with the zero-cross when the AC input voltage is positive, and the power switch is turned OFF when the ACG starting detection circuit determines that the output of the generator is not generated.

In this configuration, when power consumption of the battery is small, a voltage of the battery is not dropping, and therefore, an operation of charging the battery is stopped for a long period of time, and the gates of the FETs are maintained in the state of positive bias. As a result, the ACG starting detection circuit recognizes that the output of the generator is not generated and turns off the power switch, so that a power supply voltage of the charging control circuit is dropping. Accordingly, the charging control circuit cannot control gate potentials of the FETs, the gate voltage of the FET become the L level regardless of the timing of the zero-cross of the output of the generator, and the FET is turned OFF, and therefore, a large reaction voltage is generated by a reactance component of the generator, and a life of the battery may be shortened due to breakage or overcharging of the FETs, diodes, or others.

Accordingly, a typical preferred aim of the present invention is to provide a battery charging technique by which various battery charging control can be achieved even when the power consumption of the battery is small.

The above and other preferred aims and novel characteristics of the present invention will be apparent from the description of the present specification and the accompanying drawings.

The typical ones of the inventions disclosed in the present application will be briefly described as follows.

That is, the typical one is summarized that, in the battery charging technique for the battery charger or others, in order not to turn OFF the power switch even when the ACG starting detection circuit recognizes that the output of the generator is not generated in the state in which the power consumption of the battery is small and the voltage of the battery is not dropping, the voltage of the battery in addition to each phase-terminal signal of the generator is inputted to the ACG starting detection circuit, and the ACG starting detection circuit controls not to turn OFF the power switch when the output of the generator is generated or when the voltage of the battery is equal to or higher than a predetermined voltage.

The effects obtained by typical aspects of the present invention will be briefly described below.

That is, as the effects obtained by the typical aspects, the battery charging technique by which various battery charging control can be achieved even when the power consumption of the battery is small can be provided.

### BRIEF DESCRIPTIONS OF THE DRAWINGS

FIG. 1 is a diagram illustrating a configuration example of a battery charger according to an embodiment of the present invention;

FIG. 2 is a diagram illustrating voltage waveform examples in a configuration of a battery charger according to a conventional technique;

FIG. 3 is a diagram illustrating a configuration example of an ACG starting detection circuit in the battery charger according to the embodiment of the present invention;

FIG. 4 is a diagram illustrating a circuit example suitable for integration of an ACG starting detection circuit and a power switch in the battery charger according to the embodiment of the present invention;

FIG. 5 is a diagram illustrating another circuit example suitable for integration of the ACG starting detection circuit and the power switch in the battery charger according to the embodiment of the present invention; and

FIG. 6 is a diagram illustrating another circuit example suitable for integration of the ACG starting detection circuit and the power switch, which correspond to those in FIG. 4, in the battery charger according to the embodiment of the present invention.

### DETAILED DESCRIPTION OF THE EXEMPLARY EMBODIMENTS

Hereinafter, embodiments of the present invention will be described in detail with reference to the accompanying drawings. Note that components having the same function are denoted by the same reference symbols throughout the drawings for describing the embodiment, and the repetitive description thereof will be omitted.

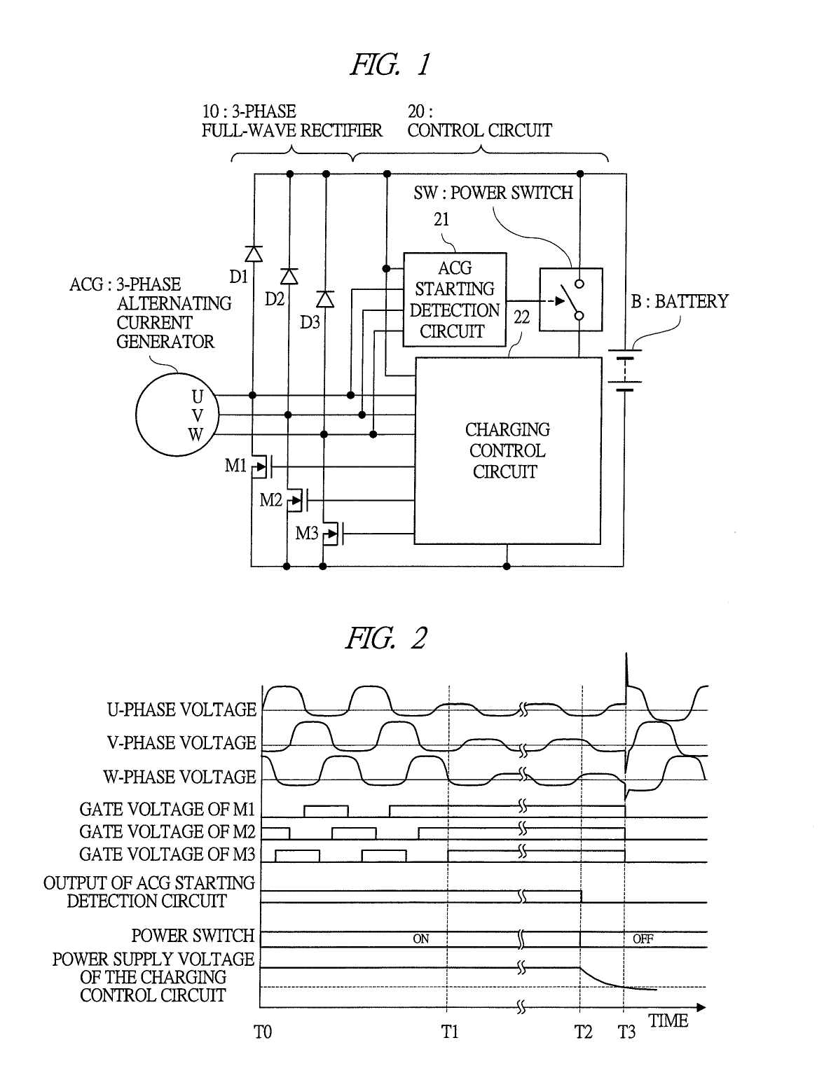

FIG. 1 is a diagram illustrating a configuration example of a battery charger according to an embodiment of the present invention.

The battery charger according to the present embodiment is a battery charger to which output of a permanent-magnet-type three-phase alternating-current generator ACG is inputted and which charges a battery B by a DC voltage rectified by a three-phase full-wave rectifier, and is composed of: a three-phase full-wave rectifier 10; and a control circuit 20.

The three-phase full-wave rectifier 10 is a circuit to which the output of the three-phase alternating-current generator ACG is inputted and which rectifies the input to a DC voltage. The three-phase full-wave rectifier 10 is composed of: a rectifying element group composed of rectifying elements D1, D2, and D3 of respective phases, which is connected to a positive side of the three-phase full-wave rectifier; and a switching element group composed of switching elements M1, M2, and M3 of respective phases, which is connected to a negative side thereof. The rectifying element group may be, for example, a Schottky-barrier-diode group composed of Schottky barrier diodes in which D1, D2, and D3 are examples of respective rectifying elements. However, the present invention is not limited to this, and the rectifying element group may be a rectifying element group in which D1, D2, and D3 are composed of other diodes. Also, the switching element group may be, for example, a FET group composed of FETs in which M1, M2, and M3 are examples of respective switching elements. However, the present invention is not limited to this, and the switching element group may be, for example, a bipolar transistor group in which M1, M2, and M3 are composed of bipolar transistors.

The control circuit 20 is a circuit which controls the switching element group composed of the switching elements M1, M2, and M3 when the battery B is charged by the DC voltage rectified by the three-phase full-wave rectifier 10. The control circuit 20 is composed of: a power switch SW which connects the DC voltage or the power of the battery B to the control circuit 20; an ACG starting detection circuit 21 which controls ON/OFF of the power switch SW in accordance with presence/absence of the output of the three-phase alternating-current generator ACG or magnitude relation between the voltage of the battery B and a predetermined voltage; and a charging control circuit 22 which controls gates of the switching element group. The charging control circuit 22 is operated in synchronization with the ON/OFF state of the power switch SW.

More particularly, in the battery charger according to the present embodiment, not only each phase terminal signal of the output of the three-phase alternating-current generator ACG but also a battery voltage signal for detecting the voltage of the battery B are connected to the ACG starting detection circuit 21.

Here, in the battery charger according to the present embodiment, an operation in a state of the battery charging will be explained.

At the same time as zero-crossing of a U-phase voltage of the three-phase alternating-current generator ACG from the negative side to the positive side, the gate potential of the switching element M1 is changed to the L level to turn OFF the switching element M1, so that a current is carried from the U-phase terminal of the three-phase alternating-current generator ACG to the positive terminal of the battery B via the rectifier element D1 to charge the battery B. Conversely, at the same time as zero-crossing of the U-phase voltage of the three-phase alternating-current generator ACG from the positive side to the negative side, the gate potential of the switching element M1 is changed to the H level to turn ON the switching element M1, so that the current from the negative terminal of the battery B is carried back to the three-phase alternating-current generator ACG.

Also, similarly to cases of V and W phases of the three-phase alternating-current generator ACG, at the same time as zero-crossing of each phase voltage from the negative side to the positive side, the respective switching elements M2 and M3 are turned OFF, and, at the same time as zero-crossing from the positive side to the negative side, the respective switching elements M2 and M3 are turned ON.

And, when the voltage of the battery B becomes higher than the predetermined voltage, the charging control circuit 22 becomes a non-charging state, and the corresponding switching elements M1, M2, and M3 are maintained to be ON even in zero-crossing of the U, V, and W phase voltages from the negative side to the positive side, so that the output current from the three-phase alternating-current generator ACG is carried back to the three-phase alternating-current generator ACG via the switching elements M1, M2, and M3 not to charge the battery B.

FIG. 2 is a diagram illustrating voltage waveform examples in a configuration of a battery charger of a conventional technique.

The charging state is illustrated from the time T0 to T1, and the gate potentials of the switching elements M1, M2, and M3 are controlled in accordance with the zero-crossing of the U, V, and W phase voltages. After the time T1, the battery voltage is higher than the predetermined voltage to cause the non-charging state, so that the gate potentials of the switching elements M1, M2, and M3 are maintained at the H level regardless of the zero-crossing of the U, V, and W phases. At this time, when the power consumption of the power accumulated in the battery B is small, it is detected that the battery voltage is lower than the predetermined voltage, so that an interval from a state that the charging control circuit 22 returns to the charging state again to a state that it starts the charging becomes longer.

In the configuration according to the conventional technique, only the phase voltage of the three-phase alternating-current generator ACG is inputted to the ACG starting detection circuit 21 to control the power switch SW, and, when the non-charging period is long, the ACG starting detection circuit 21 determines that the output of the generator is not generated, and turns OFF the power switch SW at the time T2. Accordingly, the power-supply voltage of the charging control circuit 22 is dropping, and, when it is over a certain threshold value, the gate potentials of the switching elements M1, M2, and M3 cannot be controlled, and the gate potentials of the switching elements M1, M2, and M3 are changed to the L level, and therefore, the switching elements M1, M2, and M3 are turned OFF. At this time, the timing of turning OFF the switching elements M1, M2, and M3 only depends on the power-supply voltage drop of the charging control circuit 22 and is not relevant to the zero-crossing of the U, V, and W phase voltages of the output of the three-phase alternating-current generator ACG, and therefore, a large reaction voltage is generated in the U, V, and W phase voltages by the reactance components of the three-phase alternating-current generator ACG.

On the other hand, in the configuration according to the present embodiment, as illustrated in FIG. 1, since the ACG starting detection circuit 21 also detects the battery voltage to control the power switch SW, the power switch SW is not turned OFF at the time T2 in FIG. 2, and the large reaction voltage generated at the time T3 is not generated, and therefore, there is no possibility of breakage of the switching elements M1, M2, and M3, the rectifier elements D1, D2, and D3, or others and overcharging of the battery B.

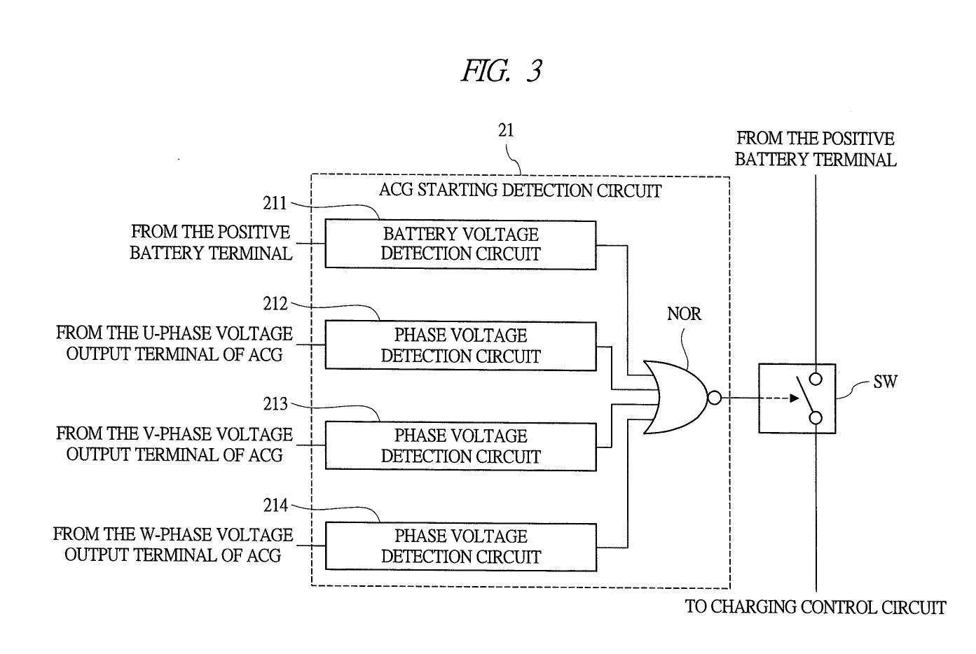

While various configurations can be considered for the ACG starting detection circuit 21 according to the present embodiment, the configuration may be, for example, the one illustrated in FIG. 3. FIG. 3 is a diagram illustrating the configuration example of the ACG starting detection circuit 21.

The ACG starting detection circuit 21 illustrated in FIG. 3 is composed of: a battery voltage detection circuit 211; phase voltage detection circuits 212, 213, and 214 for respective phases; and a NOR gate circuit NOR. The battery voltage detection circuit 211 outputs the H level when the battery voltage is equal to or higher than the predetermined voltage, or outputs the L level when the battery voltage is equal to or lower than the predetermined voltage. Each of the phase voltage detection circuits 212, 213, and 214 for the respective phases outputs the H level when the respective phase voltages are generated, or outputs the L level when the respective phase voltages are not generated.

The output of the ACG starting detection circuit 21 is generated as a NOR (Not OR) result of outputs of the battery voltage detection circuit 211 and the phase voltage detection circuits 212, 213, and 214, and the ACG starting detection circuit 21 outputs the L level when at least one of their outputs is the H level. The power switch SW is turned ON when the L level is inputted to the switch control terminal thereof and is turned OFF when the H level is inputted thereto. By this configuration, the ACG starting detection operation according to the present embodiment can be carried out. In the present configuration example, the output of the ACG starting detection circuit 21 is configured as one terminal by using the NOR gate circuit NOR. However, the output may be configured as a plurality of terminals, or a plurality of control terminals of the power switch SW, which are parallely connected to each other, may be connected to the respective output terminals.

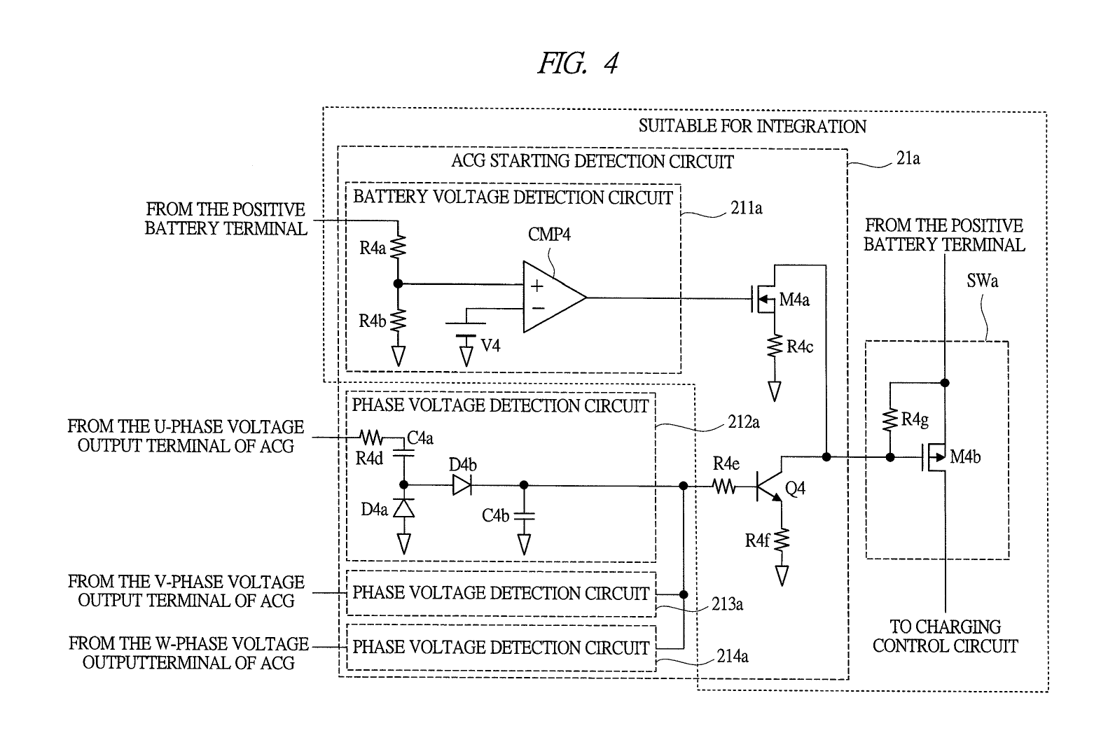

FIG. 4 is a diagram illustrating a circuit example suitable for integration of an ACG starting detection circuit 21a and a power switch SWa.

In the ACG starting detection circuit 21a illustrated in FIG. 4, the power switch SWa is composed of: a switching element M4b; and a resistor R4g, and a switch control terminal is connected to the ACG starting detection circuit 21a, and is connected between the positive battery terminal and the charging control circuit 22.

A phase voltage detection circuit 212a (similarly to 213a and 214a) is a voltage doubler rectifier circuit composed of: a resistor R4d; capacitors C4a and C4b; and diodes D4a and D4b, and the similarly-composed circuit is used for each phase of the U, V, and W phases. The inputs of the phase voltage detection circuits 212a, 213a, and 214a are connected to the respective phase terminals of the U, V, and W phases of the three-phase alternating-current generator ACG, and the outputs thereof are connected to a bipolar transistor Q4 (which is grounded via a resistor R4f) via a resistor R4e, and are further connected to the power switch SWa. In the phase voltage detection circuit 212a connected to the U-phase, when the phase voltage is generated, an output unit of the voltage doubler rectifier circuit increases a base potential of the bipolar transistor Q4 to turn ON the bipolar transistor Q4. By the current flowing from the positive battery terminal to the bipolar transistor Q4 via the resistor R4g, a potential difference is generated between both ends of the resistor R4g inside the power switch to turn ON the switching element M4b, so that the power is supplied to the charging control circuit 22. The cases that phase voltages are generated for the V and W phases are the same as that of the U phase.

A battery voltage detection circuit 211a is composed of: resistors R4a and R4b; an internal power supply V4; and a comparator CMP4. The input of the battery voltage detection circuit 211a is connected to the positive battery terminal, and the output thereof is connected to a switching element M4a (which is grounded via a resistor R4c), and is further connected to the power switch SWa. In the battery voltage detection circuit 211a, the potential of the positive battery terminal is divided by the resistors R4a and R4b, and is compared with a potential of the internal power supply V4 by the comparator CMP4. When the potential of the positive battery terminal is higher than a predetermined voltage, the H level is outputted to turn ON the switching element M4a. By the current flowing from the positive battery terminal to the switching element M4a via the resistor R4g, a potential difference is generated between both ends of the resistor R4g inside the power switch to turn ON the switching element M4b, so that the power is supplied to the charging control circuit 22. When the potential of the positive battery terminal is lower than the predetermined potential, the battery voltage detection circuit 211a outputs the L level to turn OFF the switching elements M4a and M4b, so that the power supply is shut off to the charging control circuit 22.

In the case of this circuit example, a large chip area is required for integration of the capacitors C4a and C4b of the phase voltage detection circuits 212a, 213a, and 214a, and therefore, units that the phase voltage detection circuits 212a, 213a, and 214a are excluded from the ACG starting detection circuit 21a illustrated in the diagram are suitable for the integration. However, all or a part of FIG. 4 (for example, units that the power switch SWa is excluded from the area suitable for the integration in FIG. 4, or others) may be integrated.

Circuits of the units which can be integrated are formed on a semiconductor chip, and are produced as a semiconductor integrated circuit device. In the produced semiconductor integrated circuit device, in addition to the units which can be integrated as illustrated in FIG. 4, the charging control circuit 22 illustrated in FIG. 1 is also integrated together often. Also, a form in which the integrate-circuited semiconductor integrated circuit device and other units are mounted on a wiring board becomes the battery charging circuit which configures the battery charger. The same goes for following circuit examples.

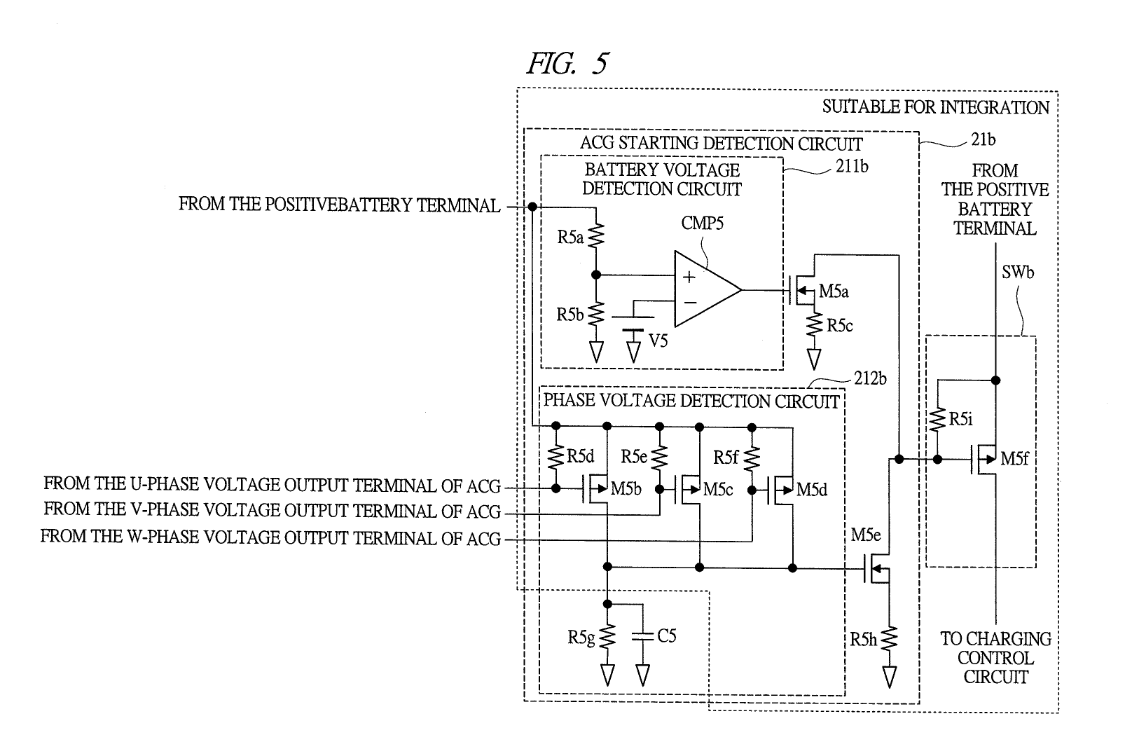

FIG. 5 is a diagram illustrating another circuit example in which the configuration of the circuit example is changed such that a larger part is suitable for the integration, and which is suitable for integration of the ACG starting detection circuit 21b and the power switch SWb.

In the configuration of the ACG starting detection circuit 21b illustrated in FIG. 5, a phase voltage detection circuit 212b is composed of one circuit composed of: resistors R5d, R5e, and R5f; switching elements M5b, M5c, and M5d; a resistor R5g; and a capacitor C5. The inputs of the phase voltage detection circuit 212b are connected to the respective phase terminals of the U, V, and W phases of the three-phase alternating-current generator ACG, and the outputs thereof are connected to a switching element M5e (which is grounded via a resistor R5h), and are further connected to the power switch SWb. The configuration of the battery voltage detection circuit 211b is same as that of FIG. 4, and is composed of: resistors R5a and R5b; an internal power supply V5; and a comparator CMP5, and is connected to a switching element M5a (which is grounded via a resistor R5c). The configuration of the power switch SWb is same as that of FIG. 4, and is composed of: a switching element M5f; and a resistor R5i.

In the ACG starting detection circuit 21b illustrated in FIG. 5, the operations for the U, V, and W phases in the phase voltage detection circuits 212b, 213b, and 214b are equivalent to each other, and therefore, the phase voltage detection operation for the U phase will be described. When the phase voltage of the U phase is lower than the potential of the positive battery terminal, the current is carried through the resistor R5d, and a potential difference is generated between terminals of the resistor R5d. When the potential difference becomes larger than the threshold voltage of the switching element M5b, the switching element M5b is turned ON to charge the capacitor C5 via the switching element M5b. When the capacitor C5 is charged, the gate potential of the switching element M5e becomes the H level to turn ON the switching element M5e, the current is carried through the resistor R5i, and the switching element M5f is turned ON, so that the power is supplied to the charging control circuit 22. When the operation of the three-phase alternating-current generator ACG is stopped, the U-phase voltage becomes equivalent to the battery voltage by the leakage currents from the rectifying elements D1, D2, and D3 connected to the positive side of the three-phase full-wave rectifier 10, and the switching element M5b is turned OFF to carry the charge charged in the capacitor C5 to the ground via the resistor R5g, and the gate potential of the switching element M5e becomes the L level to turn OFF the switching element M5e.

The battery voltage detection circuit 211b has the same configuration as that of FIG. 4, and the circuit operation thereof is also the same, and therefore, a description of the circuit operation is omitted here.

Also, an area of the circuit which is suitable for the integration is as illustrated in FIG. 5. That is, a part that the resistor R5g and the capacitor C5 of the phase voltage detection circuit 212b are excluded from the ACG starting detection circuit 21b illustrated in the diagram is suitable for the integration. However, all or a part of FIG. 5 may be integrated.

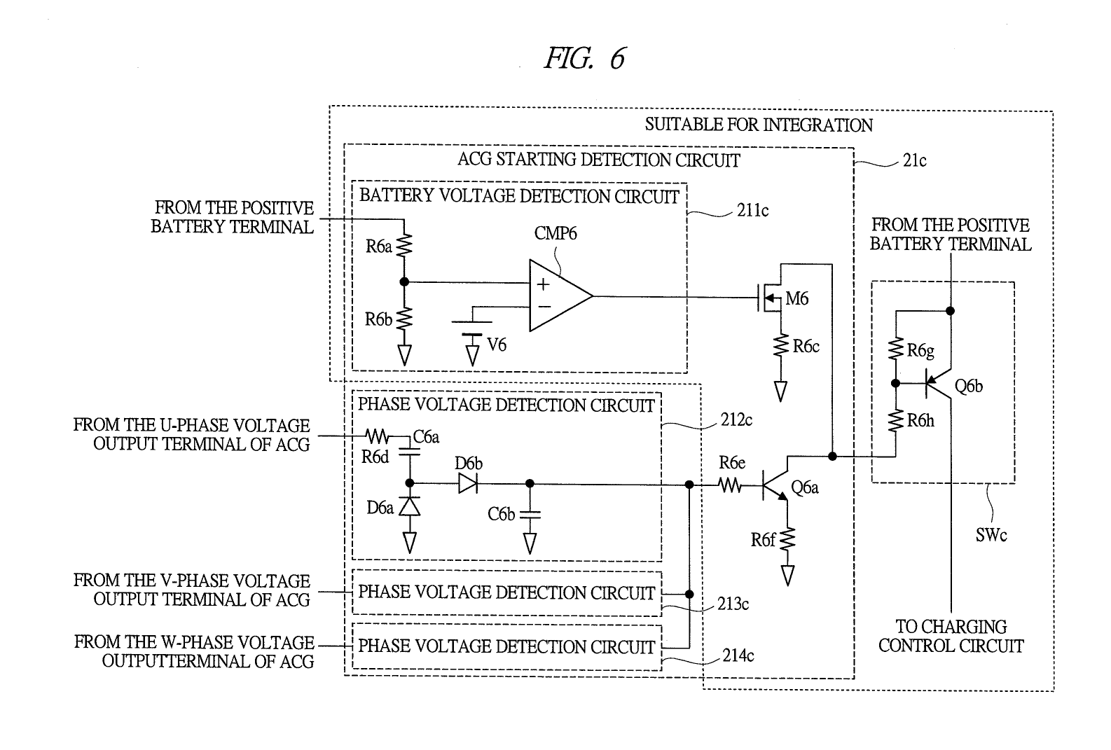

In the above-described circuit examples suitable for the integration as illustrated in FIGS. 4 and 5, the case of using the FET (PMOS) for the power switches SWa and SWb has been described. However, as another example, a case of using a bipolar transistor (PNP) for the switch is illustrated in FIG. 6. FIG. 6 is a diagram illustrating another circuit example suitable for integration of an ACG starting detection circuit 21c and a power switch SWc which correspond to those of FIG. 4. The same goes for the case corresponding to FIG. 5.

In the configuration of the ACG starting detection circuit 21c and the power switch SWc illustrated in FIG. 6, the power switch SWc is composed of: a bipolar transistor Q6b; and resistors R6g and R6h, and a switch control terminal is connected to the ACG starting detection circuit 21c, and is connected between the positive battery terminal and the charging control circuit 22. The configuration of the ACG starting detection circuit 21c is same as that of FIG. 4, and each of phase voltage detection circuits 212c, 213c, and 214c is composed of: a resistor R6d; capacitors C6a and C6b; and diodes D6a and D6b and is connected to a bipolar transistor Q6a (which is grounded via a resistor R6f) via a resistor R6e. A battery voltage detection circuit 211c is composed of: resistors R6a and R6b; an internal power supply V6; and a comparator CMP6, and is connected to a switching element M6 (which is grounded via a resistor R6c).

The operation in the configuration of the ACG starting detection circuit 21c and the power switch SWc illustrated in FIG. 6 is also same as that of the configuration of FIG. 4. When the potential of the positive battery terminal is lower than a predetermined potential, the switching element M6 is turned ON. By the current flowing from the positive battery terminal to the switching element M6 via the resistors R6g and R6h, a potential difference is generated between both ends of the resistor R6g inside the power switch, and the bipolar transistor Q6b is turned ON, so that the power is supplied to the charging control circuit 22. Conversely, when the potential of the positive battery terminal is lower than the predetermined potential, the switching element M6 and the bipolar transistor Q6b are turned OFF, so that the power supply is shut off to the charging control circuit 22.

Also in the configuration of FIG. 6, a part that the phase voltage detection circuits 212c, 213c, and 214c are excluded from the ACG starting detection circuit 21c is suitable for the integration. However, all or a part of FIG. 6 may be integrated.

According to the battery charger, the battery charging circuit, and the semiconductor integrated circuit device of the present embodiment as described above, in order not to turn OFF the power switch SW (SWa, SWb, SWc) even when the ACG starting detection circuit 21 (21a, 21b, 21c) recognizes that the output of the generator is not generated in the state in which the power consumption of the battery is low and the voltage of the battery is not dropping, the voltage of the battery B in addition to each phase terminal signal of the three-phase alternating-current generator ACG is inputted to the ACG starting detection circuit, and the ACG starting detection circuit controls not to turn OFF the power switch SW when the output of the three-phase alternating-current generator ACG is generated or when the voltage of the battery B is equal to or higher than the predetermined voltage, so that various battery charging control can be achieved even when the power consumption of the battery is small.

In the foregoing, the invention made by the inventors of the present invention has been concretely described based on the embodiments. However, it is needless to say that the present invention is not limited to the foregoing embodiments and various modifications and alterations can be made within the scope of the present invention.

What is claimed is:

1. A battery charger to which an output of a permanent-magnet-type generator is inputted and which charges a battery by a DC voltage rectified by a full-wave rectifier, wherein
the full-wave rectifier includes: a rectifying element group connected to a positive side of the full-wave rectifier; and a switching element group connected to a negative side thereof,
the battery charger includes a control circuit for controlling the switching element group,
the control circuit includes: a power switch for connecting the DC voltage or power of the battery to the control circuit; an ACG starting detection circuit for controlling ON/OFF of the power switch in accordance with presence/absence of the output power of the generator or magnitude relation between a voltage of the battery and a predetermined voltage; and a charging control circuit for controlling gates of the switch element group, and
the charging control circuit is operated in synchronization with the ON or OFF state of the power switch.

2. The battery charger according to claim 1, wherein
the ACG starting detection circuit includes: a battery voltage detection circuit for detecting the magnitude relation between the voltage of the battery and the predetermined voltage by comparing a voltage obtained by voltage division obtained by a resistor with a predetermined reference voltage.

3. The battery charger according to claim 1, wherein
the ACG starting detection circuit includes: a phase voltage detection circuit for detecting an AC input voltage from the generator and a DC input voltage from the battery by using a resistor, a capacitor, and a switching element.

4. The battery charger according to claim 1, wherein
the ACG starting detection circuit includes:
a battery voltage detection circuit, which includes a resistor, an internal power supply, and a comparator, for detecting the magnitude relation between the voltage of the battery and the predetermined voltage by comparing a voltage obtained by voltage division by the resistor with a predetermined reference voltage by the internal power supply by using the comparator; and
a phase voltage detection circuit, which includes a resistor, a capacitor, and a switching element, for detecting an AC input voltage from the generator and a DC input voltage from the battery by using the resistor, the capacitor, and the switching element.

5. A battery charging circuit comprising:
a full-wave rectifier, which includes a rectifying element group connected to a positive side of the full-wave rectifier and a switching element group connected to a negative side thereof, to which an output of a permanent-magnet-type generator is inputted, and which rectifies the input; and
a control circuit for controlling the switching element group when a battery is charged by a DC voltage rectified by the full-wave rectifier, wherein
the control circuit includes: a power switch for connecting the DC voltage or power of the battery to the control circuit; an ACG starting detection circuit for controlling ON/OFF of the power switch in accordance with presence/absence of the output of the generator or magnitude relation between a voltage of the battery and a predetermined voltage; and a charging control circuit for controlling gates of the switching element group, and
the charging control circuit is operated in synchronization with the ON or OFF state of the power switch.

6. The battery charging circuit according to claim 5, wherein
the ACG starting detection circuit includes: a battery voltage detection circuit for detecting the magnitude relation between the voltage of the battery and the predetermined voltage by comparing a voltage obtained by voltage division by a resistor with a predetermined reference voltage.

7. The battery charging circuit according to claim 5, wherein
the ACG starting detection circuit includes: a phase voltage detection circuit for detecting an AC input voltage from the generator and a DC input voltage from the battery by using a resistor, a capacitor, and a switching element.

8. The battery charging circuit according to claim 5, wherein
the ACG starting detection circuit includes:
a battery voltage detection circuit, which includes a resistor, an internal power supply, and a comparator, for detecting the magnitude relation between the voltage of the battery and the predetermined voltage by comparing a voltage obtained by voltage division by the resistor with a predetermined reference voltage by the internal power supply by using the comparator; and
a phase voltage detection circuit, which includes a resistor, a capacitor, and a switching element, for detecting an AC input voltage from the generator and a DC input voltage from the battery by using the resistor, the capacitor, and the switching element.

9. A semiconductor integrated circuit device comprising a control circuit for controlling a switch element group of a full-wave rectifier when a battery is charged by a DC voltage rectified by the full-wave rectifier to which an output of a permanent-magnet-type generator is inputted, wherein
the control circuit includes: a power switch for connecting the DC voltage or power of the battery to the control circuit; all or a part of an ACG starting detection circuit for controlling ON/OFF of the power switch in accordance with presence/absence of the output of the generator or magnitude relation between a voltage of the battery and a predetermined voltage; and a charging control circuit for controlling gates of the switch element group, and
the charging control circuit is operated in synchronization with the ON or OFF state of the power switch.

10. The semiconductor integrated circuit device according to claim 9, wherein
the ACG starting detection circuit includes: a battery voltage detection circuit for detecting the magnitude relation between the voltage of the battery and the predetermined voltage by comparing a voltage obtained by voltage division by a resistor with a predetermined reference voltage.

11. The semiconductor integrated circuit device according to claim 9, wherein
the ACG starting detection circuit includes: a phase voltage detection circuit for detecting an AC input voltage from the generator and a DC input voltage from the battery by using a resistor, a switching element, and an externally-connected capacitor.

12. The semiconductor integrated circuit device according to claim 9, wherein
the ACG starting detection circuit includes:
a battery voltage detection circuit, which includes a resistor, an internal power supply, and a comparator, for detecting the magnitude relation between the voltage of the battery and the predetermined voltage by comparing a voltage obtained by voltage division by the resistor with a predetermined reference voltage by the internal power supply by using the comparator; and
a phase voltage detection circuit, which includes a resistor and a switching element, for detecting an AC input voltage from the generator and a DC input voltage from the battery by using the resistor, the switching element, and the externally-connected capacitor.
